(19) United States
(12) Patent Application Publication
(10) Pub. No.: US 2024/0316805 A1
(43) Pub. Date: Sep. 26, 2024

(54) HAIR REMOVAL DEVICE

(71) Applicant: Church & Dwight Co., Inc., Princeton, NJ (US)

(72) Inventors: Jessica Rosenthal, New York, NY (US); Nicholas Garibaldi, Princeton, NJ (US); Gerhart P. Huy, Hamilton Square, NJ (US); Eric Langberg, Milford, PA (US); Hayley Matarazzo, Morristown, NJ (US); David Stowers, Morristown, NJ (US); Richard Concepcion, Egg Harbor Township, NJ (US); Paul Murphy, Hong Kong (CN)

(73) Assignee: Church & Dwight Co., Inc., Princeton, NJ (US)

(21) Appl. No.: 18/611,355

(22) Filed: Mar. 20, 2024

Related U.S. Application Data
(60) Provisional application No. 63/453,957, filed on Mar. 22, 2023.

(51) Int. Cl. B26B 19/06; B26B 19/38

(52) U.S. Cl. CPC B26B 19/06; B26B 19/3846; B26B 19/3873

(57) ABSTRACT

The present disclosure provides devices for removal of hair, such as by cutting of the hair. The devices can include a cutting assembly or blade assembly that can include at least one moving blade and at least one stationary blade. The blades may be provided within a blade assembly housing. A stationary blade can include an externally facing edge with a curved arrangement that improves passage of the blade assembly across skin for hair removal with reduced chance for nicking of skin or other discomfort. The blade assembly may be combined with a handle. The blade assembly may be attached to the handle so that the blade assembly is arrange for continuous rotation to a desired angle to improve case of use thereof.

### CROSS-REFERENCE TO RELATED APPLICATIONS

This application claims priority from U.S. Application No. 63/453,957, filed on Mar. 22, 2023, which application is hereby incorporated in its entirety by reference in this application.

### FIELD OF THE DISCLOSURE

The present disclosure relates to a hair removal device. More particularly, the present disclosure relates to a blade assembly that provides improved sensitivity to a user, and the present disclosure further relates to a combination of the blade assembly with a device handle, the combined blade assembly and handle providing ease of using the hair removal device at a variety of positions and angles relative to the part of the body on which the hair is to be removed.

### BACKGROUND

A variety of hair removal devices previously have been provided to achieve hair removal in a variety of manners. Electrically powered devices typically include a stationary blade and a moving blade and are configured so that hair is cut at the interface between the stationary blade and the moving blade. Such powered devices may have blade assemblies configured so that cutting occurs along a single, frontward edge of the blade assembly, such a shears used in barbering or hairdressing. Such devices are typically configured to trim a length of hair without total removal to the skin surface.

Other types of powered hair removal devices are configured to completely remove hair from a portion of the skin of a user to provide a smooth or “clean shaven” appearance. Such powered devices intended for removing facial hair (e.g., a beard) often comprise a “foil” or other perforated sheet as a stationary blade that contacts and glides along the skin and a moving blade immediately below the stationary blade so that hair enters the perforations of the metal foil to be cut by the moving blade. Powered devices likewise may have blade assemblies with a top portion that is arranged for contacting and gliding along the surface of skin of the user but have a blade assembly at one or both of a frontward edge and a rearward edge of the blade assembly. Again, these are configured with a stationary blade and a moving blade arranged to remove hair as close as possible to the surface of the skin to provide the smooth appearance to the skin.

Known, powered hair removal devices provide convenience relative to conventional methods of hair removal where a razor blade (e.g., a straight razor or safety razor) is used with a lubricant (e.g., shaving cream) to cut hair at skin level. Powered hair removal devices, however, are often believed to lack the ability to provide hair removal that matches the “closeness” to the skin that is achieved with a conventional razor blade. Likewise, devices with blade assemblies at frontward and/or rearward edges can lack comfort of use due to skin irritation caused by the leading edge of the stationary blade. Furthermore, powered hair removal devices that cut at frontward and/or rearward edges may only cut hair in a linear movement, and this can limit ease of use, particularly when removing hair from parts of the body that are not reached with sufficient case to ensure close contact of the blade assembly with the skin. Accordingly, there exists a need for electrically powered hair removal devices that address and/or solve at least the above-mentioned matters.

### BRIEF SUMMARY OF THE DISCLOSURE

The present subject matter is described herein with reference to one or more embodiments. Embodiments may be described in isolation solely for the purpose of providing a full description of specific features of the hair removal devices, and any such isolated description is not intended to limit the disclosure to individual embodiments that exclude combination with further embodiments. Rather, the present disclosure is intended to encompass any combination of two, three, four, or more of the embodiments that are described herein, as well as combinations of any two, three, four, or more features or elements of specific embodiments that are set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

In some embodiments, the present disclosure provides a blade assembly for a hair removal device. For example, the blade assembly can comprise: a blade assembly housing extending from a first end to a second end to define a longitudinal axis, from a top to a bottom, and from a front to a rear; a lateral moving blade arranged within the blade assembly housing and configured to move along the longitudinal axis of the blade assembly housing with a reciprocating motion; and a stationary blade extending from a first end to a second end to define a longitudinal axis and extending from an externally-facing edge to an internally-facing edge, the stationary blade being arranged so that a rear surface thereof is adjacent a front surface of the lateral moving blade; wherein the externally-facing edge of the stationary blade comprises a plurality of projections separated by a plurality of slots, the each of the plurality of projections defining free ends that are curved or bent away from a front surface of the stationary blade and toward the rear surface of the stationary blade, the stationary blade being arranged so that the externally-facing edge extends beyond one of the top or the bottom of the blade assembly housing. In further embodiments, the blade assembly may be further defined in relation to one or more of the following statements, which can be combined in any number and order.

The free ends of the projections can be curved or bent so as to define an angle relative to the rear surface of the stationary blade, the angle being about 15 degrees to about 130 degrees.

The free ends of the projections can be curved or bent such that tips of each of the free ends extend beyond a rear surface of the lateral moving blade.

The lateral moving blade can extend from an externally-facing edge to an internally-facing edge, the externally-facing edge of the lateral moving blade comprising a plurality of projections separated by a plurality of slots, the projections defining free ends.

The lateral moving blade can define a first lateral moving blade cutting portion that is arranged proximate the top of the blade assembly housing, and the blade assembly further can comprise a second lateral moving blade cutting portion that is arranged proximate the bottom of the blade assembly housing. Further, the stationary blade ca defines a first stationary blade that is arranged proximate the top of the blade assembly housing, and the blade assembly further can comprise a second stationary blade that is arranged proximate the bottom of the blade assembly housing.

The first lateral moving blade cutting portion and the second lateral moving blade cutting portion can be connected so as to move in unison.

The first lateral moving blade cutting portion and the second lateral moving blade cutting portion can be connected by an intervening, non-cutting piece.

The intervening, non-cutting piece can be configured for attachment to a lateral moving blade support that is positioned within the blade assembly housing away from the first lateral moving blade cutting portion and the second lateral moving blade cutting portion.

The first lateral moving blade cutting portion, the second lateral moving blade cutting portion, and the intervening, non-cutting piece can be configured as a unitary article having a substantially U-shaped structure with the first lateral moving blade cutting portion and the second lateral moving blade cutting portion defined at free ends of the U-shaped structure.

The first stationary blade and the second stationary blade can be connected at ends thereof with structural arms so that the structural arms are positioned proximate the first end of the blade assembly housing and proximate the second end of the blade assembly housing.

The first stationary blade, the second stationary blade, and the structural arms can define a unitary structure with a central opening.

The blade assembly further can comprise a central moving blade and a foil overlying the central moving blade, wherein the central moving blade is configured to move along the longitudinal axis of the blade assembly housing with a reciprocating motion, and wherein the foil is attached to a bracket within the blade assembly housing so as to remain substantially stationary when the central moving blade is moving with the reciprocating motion.

The central moving blade can extend a distance between the first end of the blade assembly housing and the second end of the blade assembly housing along the longitudinal axis of the blade assembly housing and is substantially centrally aligned between the top of the blade assembly housing and the bottom of the blade assembly housing.

Each of the central moving blade and the foil can define a convex shape toward the front of the blade assembly housing.

The rear of the blade assembly housing can comprise a connecting member configured for connecting the blade assembly with a handle.

The connecting member can be configured for rotation of the blade assembly housing relative to the handle.

The rotation can be continuous.

The continuous rotation can be indexed for stops at one or more specific points.

In some embodiments, the present disclosure can provide a hair removal device comprising a blade assembly according to any one or more of the foregoing statements in combination with, or connected to, a handle. The handle can include a power source, and electrical controller, and one or more gears powerable by the power source.

In some embodiments, the present disclosure can provide a blade assembly for a hair removal device. For example, the blade assembly can comprise: a blade assembly housing extending from a first end to a second end to define a longitudinal axis, from a top to a bottom, and from a front to a rear; one or more movable blades positioned at least partially within the blade assembly housing; and one or more stationary blades positioned at least partially within the blade assembly housing; wherein the rear of the blade assembly housing comprises a connecting member configured for connecting the blade assembly with a handle, the connecting member being configured for rotation of the blade assembly housing relative to the handle. In further embodiments, the blade assembly may be further defined in relation to one or more of the following statements, which can be combined in any number and order.

The connecting member can comprise an outer ring member and an inner ring member, the outer ring member being configured for rotation around the inner ring member.

The rotation can be continuous rotation.

The continuous rotation can be indexed for stops at one or more specific points.

One of the inner ring member and the outer ring member can comprise a plurality of detents and the other of the inner ring member and the outer ring member can comprise a plurality of grooves, the plurality of detents and the plurality of grooves being arranged so that engagement of the plurality of detents with the plurality of grooves temporarily fixes the rotational arrangement of the blade assembly relative to the handle. Further, a rotational force applied to the blade assembly can cause disengagement of the plurality of detents with the plurality of grooves so that blade assembly rotates to a different rotational arrangement relative to the handle.

The blade assembly further can comprise: a lateral moving blade arranged within the blade assembly housing and configured to move along the longitudinal axis of the blade assembly housing with a reciprocating motion; and a stationary blade extending from a first end to a second end to define a longitudinal axis and extending from an externally-facing edge to an internally-facing edge, the stationary blade being arranged so that a rear surface thereof is adjacent a front surface of the lateral moving blade; wherein the externally-facing edge of the stationary blade comprises a plurality of projections separated by a plurality of slots, the each of the plurality of projections defining free ends that are curved or bent away from a front surface of the stationary blade and toward the rear surface of the stationary blade, the stationary blade being arranged so that the externally-facing edge extends beyond one of the top or the bottom of the blade assembly housing.

The present disclosure can provide a hair removal device comprising a blade assembly according to any one or more of the foregoing statements in combination with, or connected to, a handle. The handle can include a power source, and electrical controller, and one or more gears powerable by the power source.

In some embodiments, the present disclosure can provide a blade assembly for a hair removal device. For example, the blade assembly can comprise: a blade assembly housing extending from a first end to a second end to define a longitudinal axis, from a top to a bottom, and from a front to a rear; a lateral moving blade support; a lateral moving blade comprising a central plate attached to the first moving blade support and having a top arm extending toward the front and top of the blade assembly housing and a bottom arm extending toward the front and bottom of the blade assembly housing, the top arm terminating with a top cutting section extending away from the longitudinal axis of the blade assembly housing and the bottom arm terminating with a bottom cutting section extending away from the longitudinal housing, wherein the lateral moving blade is configured to move along the longitudinal axis of the blade assembly housing with a reciprocating motion; a stationary blade extending from a first end to a second end to define a longitudinal axis, the stationary blade comprising top wing arranged to overly the top cutting section of the lateral moving blade and comprising a bottom wind arranged to overly the bottom cutting section of the lateral moving blade, wherein the top wing and the bottom wing are connected at ends thereof with structural arms so that the structural arms are positioned proximate the first end of the blade assembly housing and proximate the second end of the blade assembly housing; a central moving blade support positioned on the central plate of the lateral moving blade; a central moving blade connected to the central moving blade support, the central moving blade being configured to move along the longitudinal axis of the blade assembly housing with a reciprocating motion; and a foil overlying the central moving blade, the foil being attached to a bracket within the blade assembly housing so as to remain substantially stationary when the central moving blade is moving with the reciprocating motion. In further embodiments, the blade assembly may be further defined in relation to one or more of the following statements, which can be combined in any number and order.

The central moving blade can extend a distance between the first end of the blade assembly housing and the second end of the blade assembly along the longitudinal axis of the blade assembly housing and is substantially centrally aligned between the top of the blade assembly housing and the bottom of the blade assembly housing.

Each of the central moving blade and the foil can define a convex shape toward the front of the blade assembly housing.

The stationary blade can be configured so that the top wing, the bottom wing, and the structural arms define a unitary structure with a central opening.

The central moving blade and the foil can extend through the central opening of the stationary blade.

The blade further can comprise: a first spring extending between the rear of the blade assembly housing and the lateral blade support proximate the first end of the blade assembly housing; a second spring extending between the rear of the blade assembly housing and the lateral blade support proximate the second end of the blade assembly housing; a third spring extending between the central moving blade support and the central moving blade proximate the first end of the blade assembly housing; and a fourth spring extending between the central moving blade support and the central moving blade proximate the second end of the blade assembly housing; wherein the first spring and the third spring are coaxially aligned and the second spring and the fourth spring are coaxially aligned.

The rear of the blade assembly housing can comprise a connecting member configured for connecting the blade assembly with a handle, the connecting member being configured for rotation of the blade assembly housing relative to the handle.

The connecting member can comprise an outer ring member and an inner ring member, the outer ring member being configured for rotation around the outer ring member.

The rotation can be continuous rotation.

The continuous rotation can be indexed for stops at one or more specific points.

One of the inner ring member and the outer ring member can comprise a plurality of detents and the other of the inner ring member and the outer ring member can comprise a plurality of grooves, the plurality of detents and the plurality of grooves being arranged so that engagement of the plurality of detents with the plurality of grooves temporarily fixes the rotational arrangement of the blade assembly relative to the handle. More particularly, a rotational force applied to the blade assembly can cause disengagement of the plurality of detents with the plurality of grooves so that blade assembly rotates to a different rotational arrangement relative to the handle.

The present disclosure can provide a hair removal device comprising a blade assembly according to any one or more of the foregoing statements combined with, or connected to, a handle. The handle can include a power source, and electrical controller, and one or more gears powerable by the power source.

### BRIEF DESCRIPTION OF THE DRAWINGS

Having thus described the disclosure in general terms, reference will now be made to the accompanying drawings, which are not necessarily drawn to scale.

FIG. 1 is a perspective view of a shaving head according to an example embodiment of the present disclosure.

FIG. 2 is a side view of a shaving head according to an example embodiment of the present disclosure.

FIG. 3 is an exploded view of a shaving head according to an example embodiment of the present disclosure.

FIG. 4 is a partial, perspective view of internal components of a shaving head according to an example embodiment of the present disclosure.

FIG. 5 is a partial, perspective view of a moving blade, a stationary blade, another moving blade, and a foil of a shaving head according to an example embodiment of the present disclosure.

FIG. 6A is a detailed view of an arrangement of parts of a moving blade and a stationary blade of a shaving head according to an example embodiment of the present disclosure.

FIG. 6B is a further detailed view of an arrangement of parts of a moving blade and a stationary blade of a shaving head according to an example embodiment of the present disclosure.

FIG. 7 is a bottom view of a moving blade of a shaving head according to an example embodiment of the present disclosure.

FIG. 8 is a partially assembled view of a shaving head according to an example embodiment of the present disclosure with certain parts removed to illustrate underlying details.

FIG. 9 is a rear view of a shaving head according to an example embodiment of the present disclosure.

FIG. 10 is a detailed view of a portion of a rear of a shaving head according to an example embodiment of the present disclosure.

FIG. 11 is a perspective view of a hair removal device according to an example embodiment of the present disclosure, the hair removal device comprising a shaving head, a handle, and a charging component.

FIG. 12 is a perspective view of a hair removal device according to an example embodiment of the present disclosure, the hair removal device comprising a shaving head and a handle, the handle having body cover portions removed to reveal internal components of the handle.

FIG. 13 is a partial view of a hair removal device according to an example embodiment of the present disclosure, certain components being removed to reveal functional parts thereof.

FIG. 14 is a partial view of a hair removal device according to an example embodiment of the present disclosure, certain components being removed to reveal functional parts thereof, particularly parts positioned within the shaving head thereof.

### DETAILED DESCRIPTION OF THE INVENTION

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural variations unless the context clearly dictates otherwise.

In one or more embodiments, the present disclosure provides a blade assembly. The blade assembly may be comprised of a number of components described herein, and any combination of the components effective to form a blade assembly is expressly encompassed. The blade assembly may be particularly configured for formation of a hair removal device. For example, the blade assembly may be combined with a handle to form a hair removal device.

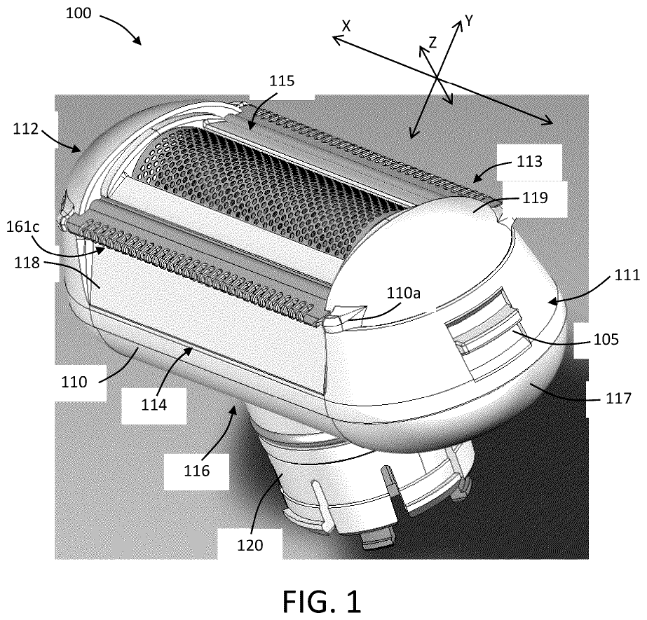

An embodiment of a blade assembly 100 according to the present disclosure is provided in FIG. 1. The blade assembly comprises a blade assembly housing 110 that contains and provide structural support for moving components and cutting components of the blade assembly. The blade assembly housing 110 defines a generally elongated structure extending from a first end 111 to a second end 112. The blade assembly housing 110 further defines a top 113 and a bottom 114. It is understood that, in some embodiments, the blade assembly 100 may be substantially symmetrical along one of both of an X-axis (defined between the first end 111 and the second end 112) and a Y-axis (defined between the top 113 and bottom 114) of the blade assembly housing 110. As such, labeling of the first end 111 and the second end 112 may be interchangeable and/or labeling of the top 113 and bottom 114 may be interchangeable. The blade assembly housing 110 further defines a front 115, which is a portion of the blade assembly 100 where hair cutting occurs, and a rear 116, which can include one or more connecting member 120 configured for connecting the blade assembly 100 with a handle. As noted, the blade assembly housing can be described in relation to an X-axis extending between the first end 111 and the second end 112 of the blade assembly housing 110, a Y-axis extending between the top 113 and the bottom 114 of the blade assembly housing 110, and a Z-axis extending between the front 115 and the rear 116 of the blade assembly. The X-axis can also define a longitudinal axis, the Y-axis can also define a lateral axis, and the Z-axis can also define a transverse axis of the blade assembly 100 and the blade assembly housing 110.

The blade assembly housing 110 may be provided as a singular structure or may comprise a plurality of components connected together to define the overall blade assembly housing. In some embodiments, the blade assembly housing 110 may comprise a blade housing base 117, a blade housing ring 118, and a blade housing cover 119. Using three components to define the blade unit housing 110 can be beneficial for case of manufacturing so that certain components can be placed in the base 117, the ring 118 can be added to provide the circumferential structure, additional components can be added into the top of the ring 118, and the cover 119 can be added to secure all parts together as a functioning blade assembly. The blade assembly housing 110 may also include one or more features for facilitating cleaning of the device—e.g., removal of cut hair that may remain within the housing. For example, a sliding door 105 can be present in the blade housing ring 118, such as at or near the first end 111 and/or the second end 112 of the blade assembly housing 110.

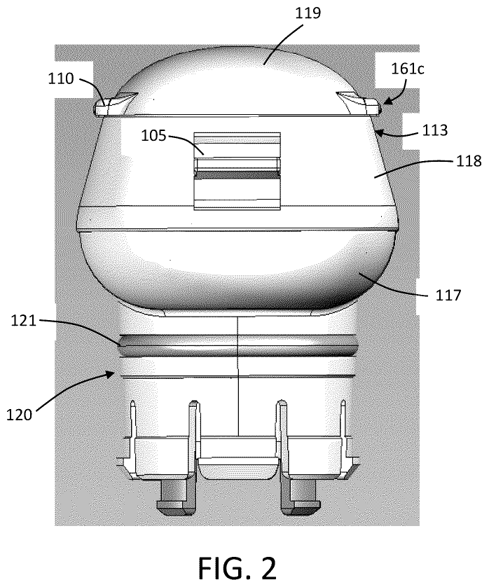

The above-described features of the blade assembly 100 and blade assembly housing 110 are further visible in the end view of FIG. 2. With reference to FIG. 2, the shapes of the blade housing base 117, a blade housing ring 118, and a blade housing cover 119, according to one embodiment, are further visible along with the sliding door 105. The connecting member 120 is further visible in FIG. 2 and can include an O-ring 121 or other sealing member useful to facilitate a connection with the handle to reduce ingress of moisture into the interior of a handle where functional components (e.g., a drive train for causing movement of one or more moving blades in the blade assembly 100) and electronic components may be housed. The connecting member 120 can be functional for facilitating rotational movement of the blade assembly 100 relative to a handle to which the blade assembly may be attached.

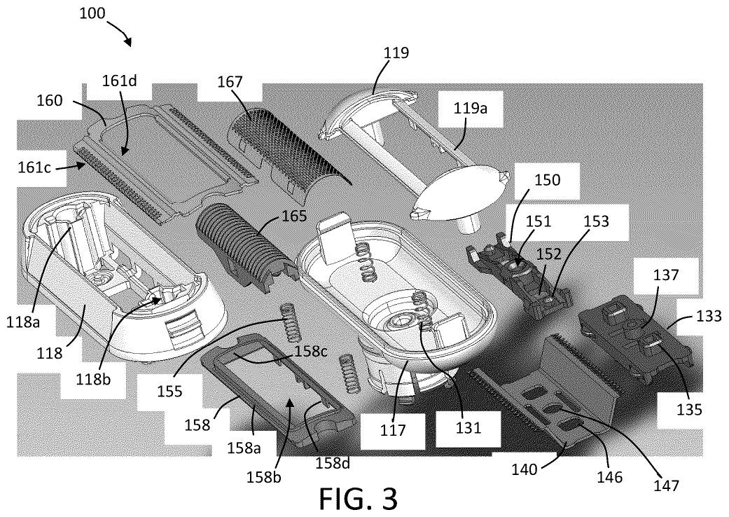

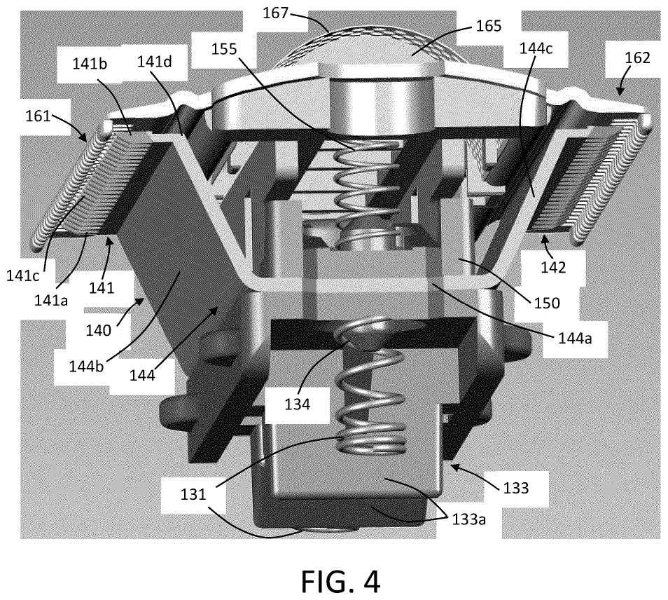

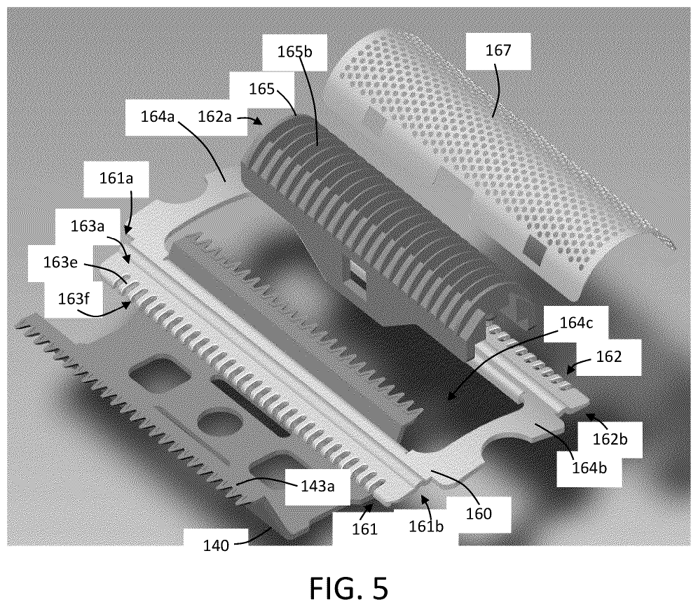

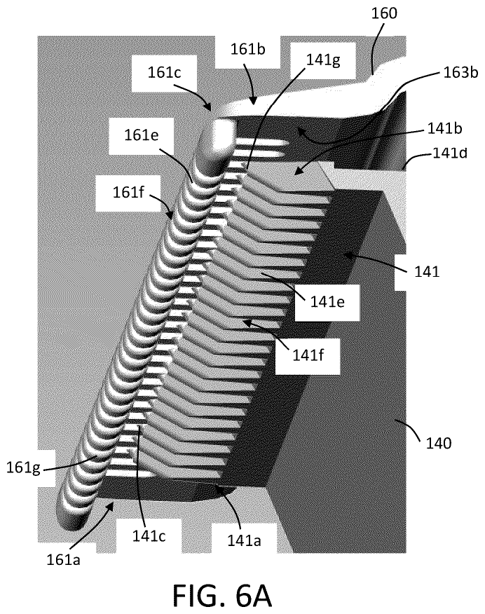

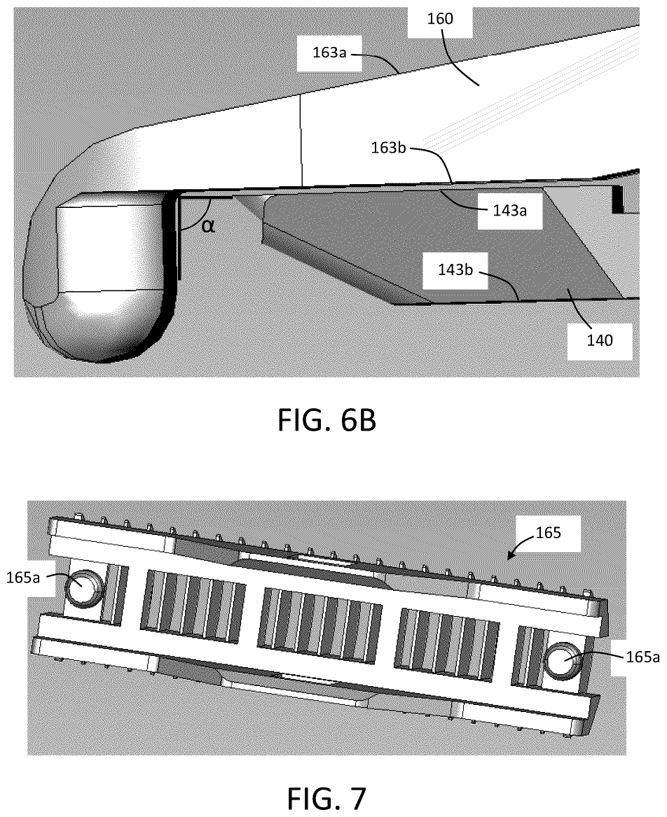

A variety of components can be included within the blade assembly housing 110 to provide functionality for hair removal. FIG. 3 provides an exploded view of components that can be used in an example embodiment of a blade assembly 100. With reference to FIG. 3, the blade assembly housing include a blade housing base 117, a blade housing ring 118, and a blade housing cover 119. Functional components within the blade assembly housing include a first pair of biasing members 131, a lateral moving blade support 133, a lateral moving blade 140, a central moving blade support 150, a second pair of biasing members 155, an internal frame 158, a stationary blade 160, a central moving blade 165 and a foil 167. Additional views of the functional components of the blade assembly 100 are illustrated in FIG. 4, FIG. 5, FIG. 6A, and FIG. 6B.

The internal components of the blade assembly 100 are illustrated in FIG. 4 in a combined state. The lateral moving blade support 133 comprises a plurality of projections 134 on an underside thereof. The projections 134 can be configured to mate with the first pair of biasing members 131 in any suitable manner such that the projections 134 and the first pair of biasing members 131 are stably connected. The lateral moving blade support 133 can be made of any suitable material, such as metal, polymers, and like materials that can efficiently provided in the desired shape and rigidity. The lateral moving blade support 133 further may include one or more tenons 135 arranged to engage one or more mortises 146 of the lateral moving blade 140. The tenons 135 can be configured to secure the lateral moving blade 140 to the lateral moving blade support 133 so that motion of the lateral moving blade support 133 is transferred to the lateral moving blade 140. The mortise(s) 146 and tenon(s) 135 may have any suitable shape that is substantially matching so as to provide a “snug” fit. For example, each of a length and width of the mortise 146 may exceed a length and width of the tenon 135 by no more than 10%, preferably no more than 5%, and more preferably no more than 3%. The lateral moving blade support 133 still further can comprise a column 137 positioned on an upper side thereof. The column 137 can be effective to provide stability and improve connectability with the central moving blade support 150, including passing through the lateral moving blade 140. The lateral moving blade 140 thus can include a matching aperture 147 through which the column 137 can pass.

The central moving blade support 150 can be formed of any suitable material and may be formed of the same material as the lateral moving blade support 133. The central moving blade support preferably is configured with features that facilitate engagement with the features on the upper side of the lateral moving blade support 133. In particular, the central moving blade support 150 can include a passageway 151 therethrough, and it can be surrounded by a column 152 on an upper side of the central moving blade support. The central moving blade support 150 also can include one or more apertures 152 substantially equal in dimensions to the mortise(s) of the lateral moving blade 140 and thus sized to receive the tenon(s) from the lateral moving blade support 133. The central moving blade support 150 still further can include one or more projections 153 on an upper side thereof and configured to mate with the second pair of biasing members 155 in any suitable manner such that the projections 153 and the second pair of biasing members 155 are stably connected. The second pair of biasing members may be the same type of component as the first pair of biasing members. For example, the biasing members may comprise springs, which can include, for example, C-shaped, I-shaped, H-shaped, M-shaped, T-shaped, U-shaped, X-shaped, W-shaped or triangular shaped springs that each apply force. Such springs may be compression, extension, torsion, linear, variable rate, or constant force springs, using a variety of configurations such as coil springs, leaf springs, flat springs, machined springs, molded springs, or any combinations of the above.

As seen from the foregoing, the lateral moving blade support 133, the lateral moving blade 140, and the central moving blade support can be combined such that the lateral moving blade 140 is positioned between the lateral moving blade support 133 and the central moving blade support 150 and may be in direct contact with one or both of the respective supports. Any one or more of the three components may be configured to be symmetrically shaped in one or more embodiments. For example, one or more may have a line of symmetry passing along the lateral axis (Y-axis). This can be particularly effective to establish a highly stable combination of moving parts without a requirement of additional materials, such as adhesives, screws, clamps, or the like. The alignment achieved by providing the lateral moving blade support 133 with a substantially centrally positioned linking member (e.g., the column 137) and two additional linking members (e.g., the tenons 135) symmetrically positioned on opposing sides of the central linking member provides high stability for the reciprocating movement that is directed to each of the moving parts in the blade assembly 100. The lateral moving blade 140 and the central moving blade support 150 can then be provided with a similarly symmetrical arrangement of openings so that the three separate components move in unison while maintaining a secure combination. This combination can be further secured by the inclusion of the biasing members, which can function to bias the moving blades into a forward, cutting arrangement, but which also can function to direct forces internally. In particular, the second pair of biasing members 155 can engage matching protrusions 165a on an underside of the central moving blade 165 so as to bias the central moving blade 165 toward the foil 167 to establish a close cutting arrangement. The second pair of biasing members 155 also exerts force on the central moving blade support 150 while the first pair of biasing members 131 directs forces toward the blade housing base 117 and also toward the lateral moving blade support 133. This results in an inward force load that adds compression to the packing of the lateral moving blade 140 between the lateral moving blade support 133 and the central moving blade support 150. The biasing members may be defined in relation to their specific arrangement. For example, in some embodiments, the blade assembly can comprise a first biasing member or spring extending between the rear of the blade assembly housing and the lateral blade support proximate the first end of the blade assembly housing, a second biasing member or spring extending between the rear of the blade assembly housing and the lateral blade support proximate the second end of the blade assembly housing, a third biasing member or spring extending between the central moving blade support and the central moving blade proximate the first end of the blade assembly housing, and a fourth biasing member or spring extending between the central moving blade support and the central moving blade proximate the second end of the blade assembly housing. In particular, the first spring and the third spring can be coaxially aligned and the second spring and the fourth spring can be coaxially aligned.

The lateral moving blade 140 can be arranged within the blade assembly housing 110 so as to be configured to move along the longitudinal axis (the X-axis-see FIG. 1) of the blade assembly housing with a reciprocating motion. The lateral moving blade 140 can be provided in a variety of forms, but it preferentially includes at least one cutting portion or section. A cutting portion 141 (or a first cutting portion if a plurality of cutting portions are present) of the lateral moving blade 140 extends from a first end 141a to a second end 141b and extends from an externally facing edge 141c to an internally-facing edge 141d. The cutting portion 141 also comprises a plurality of projections 141e separated by a plurality of slots 141f, the projections defining free ends 141g (see, in particular, FIG. 6A). In some embodiments, the lateral moving blade 140 may comprise only a single cutting portion.

In some embodiments, the lateral moving blade can define a first lateral moving blade cutting portion 141 that is arranged proximate the top 113 of the blade assembly housing 110, and the blade assembly further can comprise a second lateral moving blade cutting portion 142 that is arranged proximate the bottom 114 of the blade assembly housing. The second lateral moving blade cutting portion 142 can, in the same manner as the first lateral moving blade cutting portion 141, extend from a first end to a second end, can from an externally-facing edge to an internally-facing edge, and comprise a plurality of projections separated by a plurality of slots, the projections defining free ends.

With reference again to FIG. 4, in embodiments utilizing two lateral moving blades or two lateral moving blade cutting portions, the first lateral moving blade cutting portion 141 and the second lateral moving blade cutting portion 142 can be connected so as to move in unison. For example, the first lateral moving blade cutting portion 141 and the second lateral moving blade cutting portion 142 can be connected by at least on intervening, non-cutting piece. In particular, it can be beneficial for the cutting portions to be at a position a distance away from where the non-cutting portion attaches to the lateral moving blade support 133. The intervening, non-cutting piece 144 of the lateral moving blade 140 as illustrated comprises base piece 144a, a first arm 144b, and a second arm 144c. The base piece 144a can be configured for attachment to the lateral moving blade support 133 as otherwise described above, and the first arm 144b and the second arm 144c can have a length sufficient to provide the cutting portions at the necessary location in the blade assembly housing 110 to achieve the desired cutting efficacy. In some embodiments, the first lateral moving blade cutting portion 141 and the second lateral moving blade cutting portion may be separate elements that are combined with the intervening, non-cutting piece 144 to form the lateral moving blade 140. Likewise, the arms 144b, 144c and the base piece 144a may be separate components that are combined to form the non-cutting piece 144. In certain embodiments, the first lateral moving blade cutting portion 141, the second lateral moving blade cutting portion 142, the non-cutting portion base piece 144a, the first arm 144b, and the second arm 144c may together define a unitary structure initially formed as a monolithic piece (e.g., cast or molded from metal as a single piece). More particularly, the first lateral moving blade cutting portion 141, the second lateral moving blade cutting portion 142, and the intervening, non-cutting piece (base and both arms) can be configured as a unitary article having a substantially U-shaped structure with the first lateral moving blade cutting portion 141 and the second lateral moving blade cutting portion 142 defined at free ends of the U-shaped structure.

As noted above, the lateral moving blade 140 may be configured to only provide a single cutting portion. In such embodiments, one of the lateral moving blade cutting portions and the associated arm may be absent, and the lateral moving blade 140 thus may comprise a single cutting portion that is combined with a non-cutting portion formed of an arm connected to a base. With reference to FIG. 4, for example, the second lateral moving blade cutting portion 142 and the second arm 144c would be absent in such embodiments.

The blade assembly 100 further comprises a stationary blade 160 positioned in the blade assembly housing 110 to be functionally arranged with the lateral moving blade 140. In particular, the stationary blade 160 may be overlying at least the cutting portion(s) of the lateral moving blade 140. In particular, an under portion (or rear surface 163b) of the stationary blade 160 can be adjacent an upper portion (or front surface 143a) of the lateral moving blade 140. The stationary blade 160 is configured so that hair to be cut is directed toward the lateral moving blade 140 to be cut at an interface between the stationary blade 160 and the lateral moving blade 140. The stationary blade, however, also is configured to provide safety features that reduce or prevent opportunity for skin to be irritated, pinched, or cut by the lateral moving blade.

In one or more embodiments, the stationary blade 160 can extend from a first end 161a to a second end 161b to define a longitudinal axis (e.g., parallel to the longitudinal axis or X-axis of the blade assembly housing 110). The stationary blade 160 further can extend from an externally-facing edge 161c to an internally-facing edge 161d, the stationary blade being arranged so that a rear surface 163b thereof is adjacent a front surface of the lateral moving blade 140. The externally-facing edge 161c of the stationary blade 160 can comprise a plurality of projections 161e separated by a plurality of slots 161f. Each of the plurality of projections 161c can define free ends 161g, and the projections 161e can be configured so that the free ends 161g are curved or bent away from the front surface 163a of the stationary blade 160 and toward the rear surface 163b of the stationary blade. In some embodiments, the free ends 161g of the projections 161e can be curved or bent so as to define an angle α relative to the rear surface 163b of the stationary blade 160. In certain embodiments, the angle α can be about 15 degrees to about 130 degrees, about 30 degrees to about 125 degrees, about 45 degrees to about 120 degrees, about 60 degrees to about 115 degrees, or about 75 degrees to about 110 degrees. In specific embodiments, the angle α can be about 80 degrees to about 100 degrees.

The projections 161e of the stationary blade 160 can be configured so that the free ends 161g can have a specific shape in some embodiments. For example, the free ends 161g can be rounded. The projections 161e can be curved or bent so that tips (i.e., the terminus of each projection) the free ends 161g extend beyond the rear surface 143b of the lateral moving blade 140. The stationary blade 160 thus can be configured so that the cutting surface(s) of the lateral moving blade 140 is/are shielded away from the skin of a user irrespective of the angle of the blade assembly 100 when contacting the skin for hair removal.

In some embodiments, the stationary blade 160 can be arranged so that the externally-facing edge 161c extends beyond the top 113 (or the bottom 114, depending upon where the stationary blade is present) of the blade assembly housing 110. This is illustrated, in particular, in FIG. 1 and FIG. 2 (where the stationary blade 160 is shielded by an edge guard 110). In this manner, the lateral moving blade 140 is arranged to cut hair at the leading edge of the blade assembly 100 wherein it contacts skin, but the skin is protected by the stationary blade 160. The blade assembly housing 110 also can comprise one or more edge guards 110a. The edge guard(s) 110a can further protect against skin being irritated or nicked during use at a corner of the stationary blade 160 and the lateral moving blade 140.

Just as the blade assembly 100 can comprise a single lateral moving blade 140 in some embodiments, the stationary blade 160 can be present only at the portion of the blade assembly where the lateral moving blade 140 is present. In certain embodiments, however, such as when two lateral moving blade cutting portions are present, the stationary blade 160 can define a first stationary blade 161 that is arranged proximate the top of the blade assembly housing 110, and the stationary blade 160 further can define a second stationary blade 162 that is arranged proximate the bottom of the blade assembly housing 110. In such embodiments, the first stationary blade 161 and the second stationary blade 162 can be connected at their respective ends. More particularly, the first end 161a of the first stationary blade 161 and the first end 162a of the second stationary blade 162 can be connected through a first structural arm 164a, and the second end 161b of the first stationary blade 161 and the second end 162b of the second stationary blade 162 can be connected through a second structural arm 164b. The structural arms 164a and 164b can be positioned proximate the first end 111 of the blade assembly housing 110 and proximate the second end 112 of the blade assembly housing 110. In some embodiments, the first stationary blade 161, the second stationary blade 162, and the structural arms 164a and 164b can define a unitary structure with a central opening 164c therein.

The blade assembly 100 further comprises a central moving blade 165 and a foil 167 overlying the central moving blade 165. The foil 167 is a stationary blade that is specially designed for flexibility, strength, and comfort as it glides along skin surface and captures hairs to be cut by the underlying, moving blade. As described above, the central moving blade can be configured to move along the longitudinal axis of the blade assembly housing 110 with a reciprocating motion similar to the lateral moving blade 140. The motion can be transferred to the central moving blade 165 via the second pair of biasing members 155, which can connect with the protrusions 165a on the underside of the central moving blade 165 (see FIG. 7). The central moving blade 165 can comprise a plurality of fins 165b aligned side-to-side along the longitudinal axis of the blade assembly housing 110.

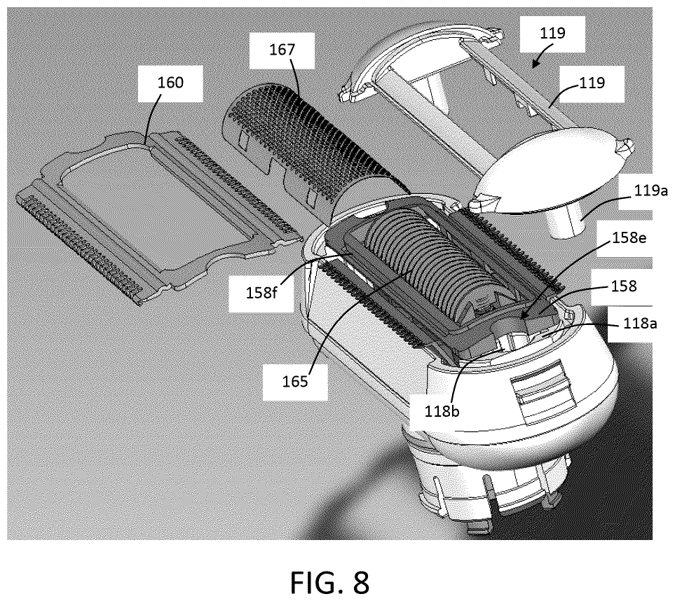

The foil 167 can be is attached to the bracket 158 within the blade assembly housing 110 so as to remain substantially stationary when the central moving blade 165 is moving with the reciprocating motion. With reference to FIG. 8, the bracket 158 is positioned atop internal frames 118a of the blade assembly housing ring 118. The internal frames 118a include channels 118b, and the bracket 158 includes end cut-outs 158e that align with an external boundary of the channels 118b. The blade assembly housing cover 119 includes poles 119a that engage the channels 118b and sit atop the bracket 158 so that the bracket remains stationary within the blade assembly 100 while the lateral moving blade 140 and central moving blade 165 are reciprocating. As seen in FIG. 8, the central moving blade 165 extends a distance between the first end 111 of the blade assembly housing 110 and the second end 112 of the blade assembly housing 110 along the longitudinal axis of the blade assembly housing and is substantially centrally aligned between the top 113 of the blade assembly housing 110 and the bottom 114 of the blade assembly housing 110. Any one or more of the moving blades, the stationary blade, and the foil can be made of any suitable materials, such as stainless steel, or other materials suitable for use in cutting devices.

In some embodiments, each of the central moving blade 165 and the foil 167 can define a convex shape toward the front 115 of the blade assembly housing 110. This arrangement can provide the blade assembly 100 with a rounded cutting surface so that an arc is defined between the externally-facing edges of the lateral moving blade 140 and the stationary blade 160 at the top 113 and bottom 114 of the housing so that a natural movement of rotating the surface of the blade assembly 100 against the skin provides for cutting of hair at the externally-facing edges and along the front of the blade assembly. The foil 167 can be formed of a metal or similar material suitable for forming a perforated sheet with strength and flexibility.

The bracket 158 can further include one or more components useful for securing other parts of the blade assembly 100 into the blade assembly housing 110. The bracket 158 can define an external frame 158a surrounding an internal opening 158b. The external frame 158a can have an internal wall 158c surrounding the internal opening 158b. The internal wall 158c can include one or more tabs 158d. The foil 167 may be secured in the blade assembly housing 110 through a plurality of slots 167a that slide around a plurality of the tabs 158d on the bracket 158. As already noted above, the bracket 158 can include cut-outs 158e to allow connection of the poles 119a of the blade assembly housing cover 119 into the channels 118b in the internal frames 118a of the blade assembly housing ring 118. The bracket 158 also can include one or more grooves 158f extending along the longitudinal length thereof, and the stationary blade 160 may comprise one or more longitudinally extending hooks 164d on either lateral side of the central opening 164c. The longitudinally extending hooks 164d can engage the grooves 158f, and the stationary blade 160 can be secured in position by such association once the blade assembly housing cover 119 is attached. In particular, the blade assembly housing cover 119 can include a plurality of rails 119a positioned to cover the portion of the stationary blade 160 where the longitudinally extending hooks 164d are positioned.

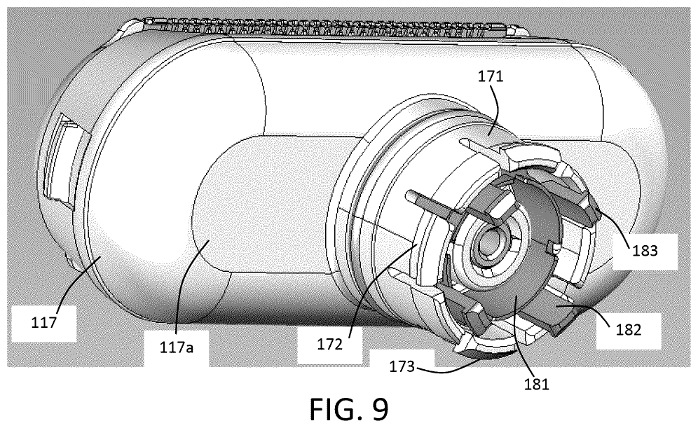

The blade assembly housing 110 also can include components so that the blade assembly can be rotated relative to a handle to which it is attached. With reference to FIG. 9, the blade housing base 117 can comprise a rear surface 117a, which can include one or more connecting members configured for connecting the blade assembly 100 with a handle 200. The one or more connecting members in particular can be configured for rotation of the blade assembly housing 110 relative to the handle 200. In some embodiments, the rotation of the blade assembly housing can be continuous, which more particularly can mean that the blade assembly housing 110 may start from a first position and be capable of rotation beyond a full 360 degrees. Such continuous rotation can be enabled in either direction. In certain embodiments, the continuous rotation can be indexed for stops at one or more specific points. This can enable rotation of the blade assembly housing 110 from a first secured position to at least a second secured position a certain arc distance away from the first position. The secured positions can maintain the rotational position of the blade assembly housing relative to the handle so that the hair removal device can be used without the blade assembly housing freely rotating. When a different position is desired, a user can manually grasp the blade assembly and rotate in the desired direction to a different secured position.

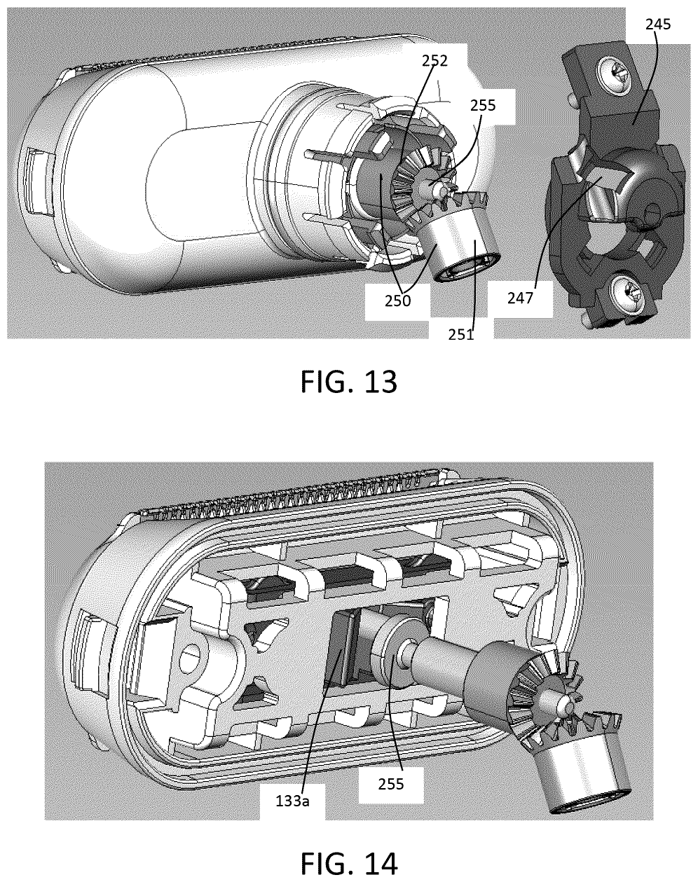

In the embodiment of FIG. 9, the connecting member 120 on the blade assembly housing base 117 comprises an outer connecting ring member 171 and an inner connecting ring member 181. The blade assembly housing 110 may be connected to a handle 200 by the outer connecting ring member 171 or the inner connecting ring member 181. As an example, the inner connecting ring member 181 can include a plurality of arms 182 and end tabs 183, and the plurality of arms can be connected to a mounting bracket 245 of the handle 200 by passage of the end tabs 183 through apertures 247 in the mounting bracket (see FIG. 13). The plurality of arms 182 thus extend beyond an end of the outer connecting ring member 171. The outer connecting ring member 171 can be divided into a plurality of segments 172, and one or more of the plurality of segments 172 also can comprise tabs 173, which can be used to improve connection of the blade assembly 100 with a handle 200. The division into a plurality of segments 172 can be effective to provide flexibility to the outer connecting ring member, which can be particularly beneficial for providing the rotation ability.

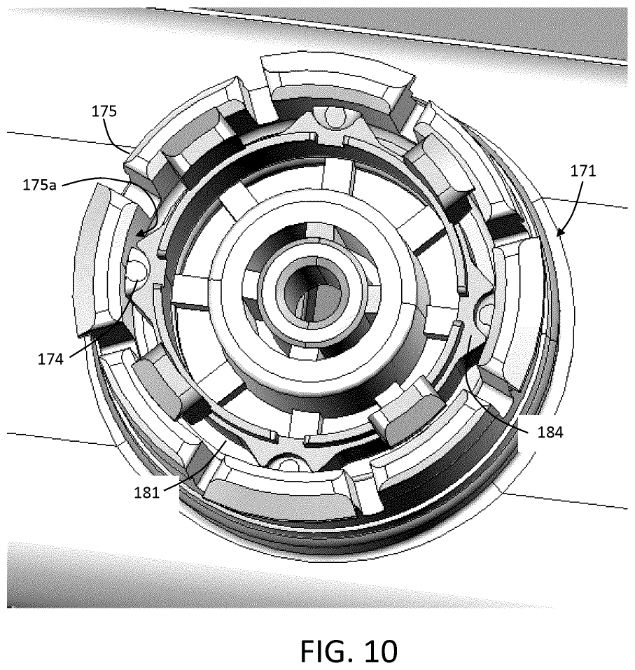

The connecting ring members 171 and 181 are further illustrated in FIG. 10. The rotation function and the indexed stops can be achieved through use of a plurality of detents one of the inner ring member and outer ring member and a plurality of grooves on the other of the inner ring member and the outer ring member. The plurality of grooves and the plurality of detents can be arranged so that engagement of the plurality of detents with the plurality of grooves temporarily fixes the rotational arrangement of the blade assembly relative to the handle. As noted above, when a rotational force is applied to the blade assembly, the rotational force causes disengagement of the plurality of detents with the plurality of grooves so that blade assembly rotates to a different rotational arrangement relative to the handle. In FIG. 10, the outer connecting ring member 171 comprises a plurality of detents 174 on inner surfaces 175a of four of the outer connecting ring member segments 175. The inner connecting ring member 181 comprises four grooved wedges 184 with the grooves being sized to engage the detents 174 of the outer connecting ring member 171. The shape of the grooved wedges 184 forces the detents 174 securely into the grooves, and a force must be applied cause the outer connecting ring member segments 174 with the detents 174 to deform or bend outward so the detent 174 can slide over the uprising on either side of the groove in the wedged groove 184. The same actions then occur to allow the blade assembly housing 110 to rotate into another of the secured positions.

As illustrated in FIG. 10, the connecting ring members 171 and 181 include four detents 174 and four matching grooved wedges 184 positioned every 90 degrees around the connecting ring members. This provides four orientations for the blade assembly relative to a handle; however, this arrangement is an example embodiment, and any arrangement of the detents 174 and grooved wedges 184 may be utilized. For example, the detents 174 and grooved wedges 184 may be positioned at 30 degree increments, 45 degree increments, or other increments. Likewise, the incrementation need not be limited to a single angle. For example, detents 174 and grooved wedges 184 may be positioned at 45 degrees, 90 degrees, 180 degrees, 210 degrees, and 330 degrees so that different angles of the blade assembly can be realized on one side of the handle relative to the other side. The connecting ring members also may be configured with fewer secured positions or more secured positions than described, and it is understood that secured positions may be established at any angle desired.

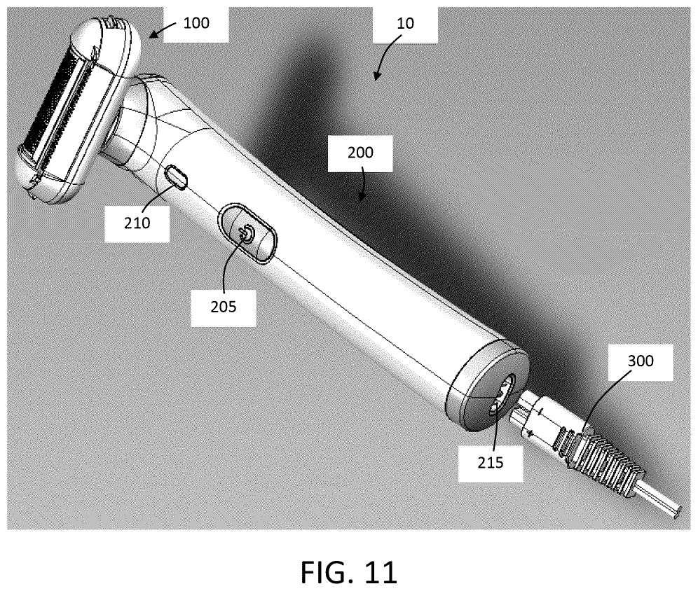

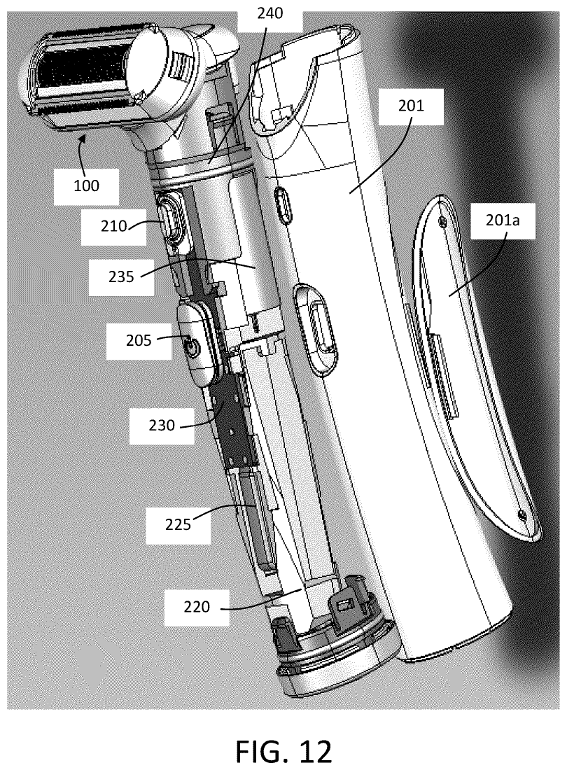

In various embodiments, the present disclosure also provides hair removal devices. With reference to FIG. 11, for example, a hair removal device 10 can comprise a blade assembly 100 connected to a handle 200. The handle 200 can comprise various combinations of components suitable for providing motion to the moving components of the blade assembly 100. At a minimum, this may include a power source, an electrical controller, and one or more gears powerable by the power source. As illustrated in FIG. 11, the handle 200 may include a power button 205 that may be illuminated by an underlying LED or equivalent lighting element. The handle 200 also may include a dedicated light 210, which specifically can be configured to illuminate an area where hair is being removed. In some embodiments, the hair removal device 10 may be rechargeable, and the handle 200 thus can include a charging port 215 with suitable electrical connections for recharging an internal battery using a charging cord 300 or like charging unit. The charging port 215 may be formed to receive the charging cord 300 with a mating male or female plug. The charging port 215 may form an industry standard connector (e.g., a USB connector, a coaxial barrel connector, a lightning connector, etc.), or may be custom-formed in a specific arrangement. Otherwise, the charging port may be arranged to receive a USB-A, USB-B, mini-USB, micro-USB, USB 3, a FIG. 8 connector, or the like.

Further components of a handle 200 of a hair removing device 10 can include any combination of the following: a chassis 220 for organizing and holding the internal components; a battery 225, which may be replaceable or rechargeable; a printed circuit board (PCB) 230, which can include one or more controller and which may be arranged for electrical connection with the power button 205 and the LED 210; a motor 235; and a motor cover 240.

The battery 225 may be particularly positioned securely within the chassis and can be directed toward an end of the housing 200 opposing the blade assembly 100 to provide for ease of charging or removal in the case of non-rechargeable batteries. The motor 235 may be a DC motor, such as, for example, a brushed DC motor, a brushless DC motor, a stepper motor, and the like. Alternatively, the motor 40 may be a brushless AC motor or a linear motor. The handle 200 may have an outer cover 201, and can include a backstrap 201a, if desired, to provide decoration and/or gripping function. The outer cover may be formed of a polymeric material such as plastic, which may be formed from a renewable material such as corn or cellulose, or may be a polymer, such as polyvinyl chloride, polyethylene terephthalate (PET), high density polyethylene (HDPE), or like materials. The outer cover 201 may be formed by three-dimensional (3D) printing, machining, casting, molding, vacuum forming, or any similar type of manufacturing method that yields the desired shape of the handle. The backstrap 201a, if present, may be formed of an elastomeric polymer that provides improved gripping of the handle 200.

With reference to FIG. 13 and FIG. 14, additional parts of the hair removal device 10 are illustrated, and these may reside in the handle 200, in the blade assembly, or in an intervening section of the hair removal device. In particular, a transmission 250 is provided and can include a lower gear 251 and an upper gear 252. The lower gear 251 can attach to a part of the motor which, when powered, rotates and causes the lower gear 251 to rotate. This motion is transferred to the upper gear 252, which includes a transmission arm 255, which extends into the blade assembly and is positioned between wings 133a of the lateral moving blade support 130. The wings 133a are substantially parallel, and the portion of the transmission arm 255 positioned between the wings 133a has an offset extension arranged so that, as the transmission arm is turned by the gears, the offset extension alternatingly contacts the individual wings 133a. The alternating contact causes the lateral moving blade support 130 to move alternatingly in the longitudinal direction (i.e., along the X-axis) of the blade assembly housing to provide the reciprocating motion of the lateral moving blade 140 and the central moving blade 165.

The present disclosure may encompass any combination of components as described above and/or as illustrated in the accompanying drawings. This may particularly include the following embodiments individually or in combination and may also include any of the following embodiments modified to include additional components described herein and/or illustrated in the accompanying drawings.

In a first example embodiment, the present disclosure provides a blade assembly for a hair removal device, and the blade assembly can comprise: a blade assembly housing 110 extending from a first end 111 to a second end 112 to define a longitudinal axis, from a top 113 to a bottom 114, and from a front 115 to a rear 116; a lateral moving blade 140 arranged within the blade assembly housing 110 and configured to move along the longitudinal axis of the blade assembly housing 10 with a reciprocating motion; and a stationary blade 160 extending from a first end 161a to a second end 161b to define a longitudinal axis and extending from an externally-facing edge 161c to an internally-facing edge 161d, the stationary blade 161 being arranged so that a rear surface 163b thereof is adjacent a front surface 143a of the lateral moving blade 140; wherein the externally-facing edge 161c of the stationary blade 160 comprises a plurality of projections 161e separated by a plurality of slots 161f, each of the plurality of projections 161e defining free ends 161g that are curved or bent away from a front surface 163a of the stationary blade 160 and toward the rear surface 163b of the stationary blade 160, the stationary blade 160 being arranged so that the externally-facing edge 161c extends beyond one of the top 113 or the bottom 114 of the blade assembly housing.

In a second example embodiment, the first example embodiment may be further defined as follows: the lateral moving blade 140 can define a first lateral moving blade cutting portion 141 that is arranged proximate the top 113 of the blade assembly housing 110, and the blade assembly further can comprise a second lateral moving blade cutting portion 142 that is arranged proximate the bottom 114 of the blade assembly housing 110; and the stationary blade 160 can comprise a first stationary blade 161 that is arranged proximate the top 113 of the blade assembly housing 110, and a second stationary blade 162 that is arranged proximate the bottom 114 of the blade assembly housing 110. This second example embodiment may be further defined in relation to any one or more of the following, which are combinable in any order. The first lateral moving blade cutting portion 141 and the second lateral moving blade cutting portion 142 can be connected so as to move in unison. The first lateral moving blade cutting portion 141 and the second lateral moving blade cutting portion 142 can be connected by an intervening, non-cutting piece 144. The intervening, non-cutting piece 144 can be configured for attachment to a lateral moving blade support 133 that is positioned within the blade assembly housing 110 away from the first lateral moving blade cutting portion 141 and the second lateral moving blade cutting portion 141. The first lateral moving blade cutting portion 141, the second lateral moving blade cutting portion 142, and the intervening, non-cutting piece 144 can be configured as a unitary article having a substantially U-shaped structure with the first lateral moving blade cutting portion 141 and the second lateral moving blade cutting portion 142 defined at free ends of the U-shaped structure. The first stationary blade 161 and the second stationary blade 162 can be connected at ends thereof with structural arms so that the structural arms are positioned proximate the first end of the blade assembly housing and proximate the second end of the blade assembly housing. The first stationary blade 161, the second stationary blade 162, and the structural arms 164a, 164b can define a unitary structure with a central opening 164c.

Optionally, in relation to the first example embodiment and the second example embodiment, any one or more of the following conditions may apply, it being understood that the disclosure expressly encompasses combinations in any number and in any order, include combination with both of the first example embodiment and the second example embodiment. The free ends 161g of the projections 161e can be curved or bent so as to define an angle relative to the rear surface 163b of the stationary blade 160, the angle being about 15 degrees to about 130 degrees (or any other range otherwise described herein). The free ends 161g of the projections 161e can be curved or bent such that tips of each of the free ends 161g extend beyond a rear surface 143b of the lateral moving blade 140. The lateral moving blade 140 can extend from an externally-facing edge 141c to an internally-facing edge 141d, the externally-facing edge of the lateral moving blade comprising a plurality of projections 141e separated by a plurality of slots 141f, the projections defining free ends 141g. The blade assembly further can comprise a central moving blade 165 and a foil 167 overlying the central moving blade, wherein the central moving blade 165 can be configured to move along the longitudinal axis of the blade assembly housing 110 with a reciprocating motion, and wherein the foil 167 can be attached to a bracket 158 within the blade assembly housing 110 so as to remain substantially stationary when the central moving blade 165 is moving with the reciprocating motion. The central moving blade 165 can extend a distance between the first end 111 of the blade assembly housing 110 and the second end 112 of the blade assembly housing along the longitudinal axis of the blade assembly housing and is substantially centrally aligned between the top 113 of the blade assembly housing and the bottom 114 of the blade assembly housing. Each of the central moving blade 165 and the foil 167 can define a convex shape toward the front 115 of the blade assembly housing 110. The rear 116 of the blade assembly housing 110 can comprise a connecting member 120 configured for connecting the blade assembly 100 with a handle 200. The connecting member 120 can be configured for rotation of the blade assembly housing 110 relative to the handle 200, and the rotation optionally can be continuous. The continuous rotation can be indexed for stops at one or more specific points. The connecting member 120 can comprise an outer connecting ring member 171 and an inner connecting ring member 181. The outer connecting ring member 171 and an inner connecting ring member 181 can comprise detents on one of the members and grooved wedges on the other of the members that interact to provide the indexed stops.

In a third example embodiment, the present disclosure provides a blade assembly for a hair removal device, and the blade assembly can comprise: a blade assembly housing 110 extending from a first end 111 to a second end 112 to define a longitudinal axis, from a top 113 to a bottom 114, and from a front 115 to a rear 116; one or more movable blades 140, 165 positioned at least partially within the blade assembly housing 110; and one or more stationary blades 160, 167 positioned at least partially within the blade assembly housing 110; wherein the rear 116 of the blade assembly housing 110 comprises a connecting member 120 configured for connecting the blade assembly 100 with a handle 200, the connecting member 120 being configured for rotation of the blade assembly housing 110 relative to the handle 200.

In a fourth example embodiment, the blade assembly of the third example embodiment can further comprise the following: a lateral moving blade 140 arranged within the blade assembly housing 110 and configured to move along the longitudinal axis of the blade assembly housing 110 with a reciprocating motion; and a stationary blade 160 extending from a first end 161a to a second end 161b to define a longitudinal axis and extending from an externally-facing edge 161c to an internally-facing edge 161c, the stationary blade being arranged so that a rear surface 163b thereof is adjacent a front surface 143a of the lateral moving blade 140; wherein the externally-facing edge 161c of the stationary blade 160 comprises a plurality of projections 161c separated by a plurality of slots 161f, each of the plurality of projections defining free ends 161g that are curved or bent away from a front surface 163a of the stationary blade 160 and toward the rear surface 163b of the stationary blade, the stationary blade 160 being arranged so that the externally-facing edge 161c extends beyond one of the top 113 or the bottom 114 of the blade assembly housing 110.

Optionally, in relation to the third example embodiment and the fourth example embodiment, any one or more of the following conditions may apply, it being understood that the disclosure expressly encompasses combinations in any number and in any order, including combination with both of the third example embodiment and the fourth example embodiment. The connecting member 120 can comprise an outer ring member 171 and an inner ring member 181, the outer ring member being configured for rotation around the inner ring member. The rotation can be continuous rotation. The continuous rotation can be indexed for stops at one or more specific points. One of the inner ring member 181 and the outer ring member 171 can comprise a plurality of detents 174 and the other of the inner ring member and the outer ring member can comprise a plurality of grooves (e.g., grooved wedges 184), the plurality of detents and the plurality of grooves being arranged so that engagement of the plurality of detents with the plurality of grooves temporarily fixes the rotational arrangement of the blade assembly 100 relative to the handle 200, and wherein a rotational force applied to the blade assembly 100 causes disengagement of the plurality of detents with the plurality of grooves so that blade assembly rotates to a different rotational arrangement relative to the handle 200.

In a fifth example embodiment, the present disclosure provides a blade assembly for a hair removal device, and the blade assembly can comprise: a blade assembly housing 110 extending from a first end 111 to a second end 112 to define a longitudinal axis, from a top 113 to a bottom 114, and from a front 115 to a rear 116; a lateral moving blade support 133; a lateral moving blade 140 that can comprise a central plate 144a attached to the lateral moving blade support 133 and having a top arm 144b extending toward the front 115 and top 113 of the blade assembly housing 110 and a bottom arm 144c extending toward the front 115 and bottom 114 of the blade assembly housing 110, the top arm 144b terminating with a first lateral moving blade cutting portion 141 extending away from the longitudinal axis of the blade assembly housing 110 and the bottom arm terminating with a second lateral moving blade cutting portion 142 extending away from the longitudinal axis of the blade assembly housing, wherein the lateral moving blade 140 is configured to move along the longitudinal axis of the blade assembly housing 110 with a reciprocating motion; a stationary blade 160 extending from a first end to a second end to define a longitudinal axis, the stationary blade comprising first stationary blade 161 arranged to overly the first lateral moving blade and comprising a second stationary blade 162 arranged to overly the second lateral moving blade, wherein the first stationary blade 161 and the second stationary blade 162 are connected at ends thereof with structural arms 164a, 164b so that the structural arms are positioned proximate the first end 111 of the blade assembly housing and proximate the second end 112 of the blade assembly housing; a central moving blade support 150 positioned on the central plate 144a of the lateral moving blade 140; a central moving blade 165 connected to the central moving blade support 150, the central moving blade 165 being configured to move along the longitudinal axis of the blade assembly housing 110 with a reciprocating motion; and a foil 167 overlying the central moving blade 165, the foil 167 being attached to a bracket 158 within the blade assembly housing 110 so as to remain substantially stationary when the central moving blade 165 is moving with the reciprocating motion.

Optionally, in relation to the fifth example embodiment, any one or more of the following conditions may apply, it being understood that the disclosure expressly encompasses combinations in any number and in any order. The central moving blade 165 can extend a distance between the first end 111 of the blade assembly housing 110 and the second end 112 of the blade assembly housing along the longitudinal axis of the blade assembly housing and is substantially centrally aligned between the top 113 of the blade assembly housing and the bottom 114 of the blade assembly housing. Each of the central moving blade 165 and the foil 167 can define a convex shape toward the front 115 of the blade assembly housing 110. The stationary blade 160 can be configured so that the first stationary blade 161, the second stationary blade 162, and the structural arms 164a, 164b define a unitary structure with a central opening 164c. The central moving blade 165 and the foil 167 can extend through the central opening 164c of the stationary blade 160. The blade assembly further can comprise: a first spring extending between the rear of the blade assembly housing and the lateral moving blade support 133 proximate the first end 111 of the blade assembly housing 110; a second spring extending between the rear of the blade assembly housing 110 and the lateral moving blade support 133 proximate the second end 112 of the blade assembly housing 110; a third spring extending between the central moving blade support 150 and the central moving blade 165 proximate the first end 111 of the blade assembly housing 110; and a fourth spring extending between the central moving blade support 150 and the central moving blade 165 proximate the second end 112 of the blade assembly housing 110; wherein the first spring and the third spring are coaxially aligned and the second spring and the fourth spring are coaxially aligned. The rear 116 of the blade assembly housing 110 can comprise a connecting member 120 configured for connecting the blade assembly 100 with a handle 200. The connecting member 120 can be configured for rotation of the blade assembly housing 110 relative to the handle 200, and the rotation optionally can be continuous. The continuous rotation can be indexed for stops at one or more specific points. The connecting member 120 can comprise an outer connecting ring member 171 and an inner connecting ring member 181. The outer connecting ring member 171 and an inner connecting ring member 181 can comprise detents on one of the members and grooved wedges on the other of the members that interact to provide the indexed stops.

In a sixth embodiment, the present disclosure can provide a hair removal device comprising a blade assembly 100 according to any of the foregoing embodiments, the blade assembly being connected to a handle 200. The handle 200 can include any of the functional components already described above.

The foregoing description of use of the device can be applied to the various implementations described herein through minor modifications, which can be apparent to the person of skill in the art in light of the further disclosure provided herein. The above description of use, however, is not intended to limit the use of the article but is provided to comply with all necessary requirements of disclosure of the present disclosure.

Many modifications and other implementations of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A blade assembly for a hair removal device, the blade assembly comprising:
a blade assembly housing extending from a first end to a second end to define a longitudinal axis, from a top to a bottom, and from a front to a rear;
a lateral moving blade arranged within the blade assembly housing and configured to move along the longitudinal axis of the blade assembly housing with a reciprocating motion; and
a stationary blade extending from a first end to a second end to define a longitudinal axis and extending from an externally-facing edge to an internally-facing edge, the stationary blade being arranged so that a rear surface thereof is adjacent a front surface of the lateral moving blade;
wherein the externally-facing edge of the stationary blade comprises a plurality of projections separated by a plurality of slots, the each of the plurality of projections defining free ends that are curved or bent away from a front surface of the stationary blade and toward the rear surface of the stationary blade, the stationary blade being arranged so that the externally-facing edge extends beyond one of the top or the bottom of the blade assembly housing.

2. The blade assembly of claim 1, wherein the free ends of the projections are curved or bent so as to define an angle relative to the rear surface of the stationary blade, the angle being about 15 degrees to about 130 degrees.

3. The blade assembly of claim 1, wherein the free ends of the projections are curved or bent such that tips of each of the free ends extend beyond a rear surface of the lateral moving blade.

4. The blade assembly of claim 1, wherein the lateral moving blade extends from an externally-facing edge to an internally-facing edge, the externally-facing edge of the lateral moving blade comprising a plurality of projections separated by a plurality of slots, the projections defining free ends.

5. The blade assembly of claim 1, wherein:
the lateral moving blade defines a first lateral moving blade cutting portion that is arranged proximate the top of the blade assembly housing, and the blade assembly further comprises a second lateral moving blade cutting portion that is arranged proximate the bottom of the blade assembly housing; and
the stationary blade defines a first stationary blade that is arranged proximate the top of the blade assembly housing, and the blade assembly further comprises a second stationary blade that is arranged proximate the bottom of the blade assembly housing.

6. The blade assembly of claim 5, wherein the first lateral moving blade cutting portion and the second lateral moving blade cutting portion are connected so as to move in unison.

7. The blade assembly of claim 6, wherein the first lateral moving blade cutting portion and the second lateral moving blade cutting portion are connected by an intervening, non-cutting piece.

8. The blade assembly of claim 7, wherein the intervening, non-cutting piece is configured for attachment to a lateral moving blade support that is positioned within the blade assembly housing away from the first lateral moving blade cutting portion and the second lateral moving blade cutting portion.

9. The blade assembly of claim 7, wherein the first lateral moving blade cutting portion, the second lateral moving blade cutting portion, and the intervening, non-cutting piece are configured as a unitary article having a substantially U-shaped structure with the first lateral moving blade cutting portion and the second lateral moving blade cutting portion defined at free ends of the U-shaped structure.

10. The blade assembly of claim 5, wherein the first stationary blade and the second stationary blade are connected at ends thereof with structural arms so that the structural arms are positioned proximate the first end of the blade assembly housing and proximate the second end of the blade assembly housing.

11. The blade assembly of claim 10, wherein the first stationary blade, the second stationary blade, and the structural arms define a unitary structure with a central opening.

12. The blade assembly of claim 1, further comprising a central moving blade and a foil overlying the central moving blade, wherein the central moving blade is configured to move along the longitudinal axis of the blade assembly housing with a reciprocating motion, and wherein the foil is attached to a bracket within the blade assembly housing so as to remain substantially stationary when the central moving blade is moving with the reciprocating motion.

13. The blade assembly of claim 12, wherein the central moving blade extends a distance between the first end of the blade assembly housing and the second end of the blade assembly housing along the longitudinal axis of the blade assembly housing and is substantially centrally aligned between the top of the blade assembly housing and the bottom of the blade assembly housing.

14. The blade assembly of claim 12, wherein each of the central moving blade and the foil defines a convex shape toward the front of the blade assembly housing.

15. The blade assembly of claim 1, wherein the rear of the blade assembly housing comprises a connecting member configured for connecting the blade assembly with a handle.

16. The blade assembly of claim 15, wherein the connecting member is configured for rotation of the blade assembly housing relative to the handle.

17. The blade assembly of claim 16, wherein the rotation is continuous, and wherein the continuous rotation is indexed for stops at one or more specific points.

18. A hair removal device comprising a blade assembly according to claim 1 and connected to a handle.

19. The hair removal device of claim 18, wherein the handle includes a power source, and electrical controller, and one or more gears powerable by the power source.

20. A blade assembly for a hair removal device, the blade assembly comprising:
a blade assembly housing extending from a first end to a second end to define a longitudinal axis, from a top to a bottom, and from a front to a rear;
one or more movable blades positioned at least partially within the blade assembly housing; and
one or more stationary blades positioned at least partially within the blade assembly housing;
wherein the rear of the blade assembly housing comprises a connecting member configured for connecting the blade assembly with a handle, the connecting member being configured for rotation of the blade assembly housing relative to the handle.

21. The blade assembly of claim 20, wherein the connecting member comprises an outer ring member and an inner ring member, the outer ring member being configured for rotation around the inner ring member.

22. The blade assembly of claim 21, wherein the rotation is continuous rotation, and wherein the continuous rotation is indexed for stops at one or more specific points.

23. The blade assembly of claim 21, wherein one of the inner ring member and the outer ring member comprises a plurality of detents and the other of the inner ring member and the outer ring member comprises a plurality of grooves, the plurality of detents and the plurality of grooves being arranged so that engagement of the plurality of detents with the plurality of grooves temporarily fixes the rotational arrangement of the blade assembly relative to the handle, and wherein a rotational force applied to the blade assembly causes disengagement of the plurality of detents with the plurality of grooves so that blade assembly rotates to a different rotational arrangement relative to the handle.

24. The blade assembly of claim 20, further comprising
a lateral moving blade arranged within the blade assembly housing and configured to move along the longitudinal axis of the blade assembly housing with a reciprocating motion; and
a stationary blade extending from a first end to a second end to define a longitudinal axis and extending from an externally-facing edge to an internally-facing edge, the stationary blade being arranged so that a rear surface thereof is adjacent a front surface of the lateral moving blade;
wherein the externally-facing edge of the stationary blade comprises a plurality of projections separated by a plurality of slots, the each of the plurality of projections defining free ends that are curved or bent away from a front surface of the stationary blade and toward the rear surface of the stationary blade, the stationary blade being arranged so that the externally-facing edge extends beyond one of the top or the bottom of the blade assembly housing.

25. A hair removal device comprising a blade assembly according to claim 21 and connected to a handle.

26. The hair removal device of claim 25, wherein the handle includes a power source, and electrical controller, and one or more gears powerable by the power source.

27. A blade assembly for a hair removal device, the blade assembly comprising:
a blade assembly housing extending from a first end to a second end to define a longitudinal axis, from a top to a bottom, and from a front to a rear;
a lateral moving blade support;
a lateral moving blade comprising a central plate attached to the first moving blade support and having a top arm extending toward the front and top of the blade assembly housing and a bottom arm extending toward the front and bottom of the blade assembly housing, the top arm terminating with a top cutting section extending away from the longitudinal axis of the blade assembly housing and the bottom arm terminating with a bottom cutting section extending away from the longitudinal housing, wherein the lateral moving blade is configured to move along the longitudinal axis of the blade assembly housing with a reciprocating motion;
a stationary blade extending from a first end to a second end to define a longitudinal axis, the stationary blade comprising top wing arranged to overly the top cutting section of the lateral moving blade and comprising a bottom wind arranged to overly the bottom cutting section of the lateral moving blade, wherein the top wing and the bottom wing are connected at ends thereof with structural arms so that the structural arms are positioned proximate the first end of the blade assembly housing and proximate the second end of the blade assembly housing;
a central moving blade support positioned on the central plate of the lateral moving blade;
a central moving blade connected to the central moving blade support, the central moving blade being configured to move along the longitudinal axis of the blade assembly housing with a reciprocating motion; and
a foil overlying the central moving blade, the foil being attached to a bracket within the blade assembly housing so as to remain substantially stationary when the central moving blade is moving with the reciprocating motion.

28. The blade assembly of claim 27, wherein the central moving blade extends a distance between the first end of the blade assembly housing and the second end of the blade assembly along the longitudinal axis of the blade assembly housing and is substantially centrally aligned between the top of the blade assembly housing and the bottom of the blade assembly housing.

29. The blade assembly of claim 27, wherein each of the central moving blade and the foil defines a convex shape toward the front of the blade assembly housing.

30. The blade assembly of claim 27, wherein the stationary blade is configured so that the top wing, the bottom wing, and the structural arms define a unitary structure with a central opening.

31. The blade assembly of claim 30, wherein the central moving blade and the foil extend through the central opening of the stationary blade.

32. The blade assembly of claim 27, further comprising:
a first spring extending between the rear of the blade assembly housing and the lateral blade support proximate the first end of the blade assembly housing;
a second spring extending between the rear of the blade assembly housing and the lateral blade support proximate the second end of the blade assembly housing;
a third spring extending between the central moving blade support and the central moving blade proximate the first end of the blade assembly housing; and
a fourth spring extending between the central moving blade support and the central moving blade proximate the second end of the blade assembly housing;
wherein the first spring and the third spring are coaxially aligned and the second spring and the fourth spring are coaxially aligned.

33. The blade assembly of claim 27, wherein the rear of the blade assembly housing comprises a connecting member configured for connecting the blade assembly with a handle, the connecting member being configured for rotation of the blade assembly housing relative to the handle.

34. The blade assembly of claim 33, wherein the connecting member comprises an outer ring member and an inner ring member, the outer ring member being configured for rotation around the outer ring member.

35. The blade assembly of claim 34, wherein the rotation is continuous rotation, and wherein the continuous rotation is indexed for stops at one or more specific points.

36. The blade assembly of claim 34, wherein one of the inner ring member and the outer ring member comprises a plurality of detents and the other of the inner ring member and the outer ring member comprises a plurality of grooves, the plurality of detents and the plurality of grooves being arranged so that engagement of the plurality of detents with the plurality of grooves temporarily fixes the rotational arrangement of the blade assembly relative to the handle, and wherein a rotational force applied to the blade assembly causes disengagement of the plurality of detents with the plurality of grooves so that blade assembly rotates to a different rotational arrangement relative to the handle.

37. A hair removal device comprising a blade assembly according to claim 29 and connected to a handle, wherein the handle includes a power source, and electrical controller, and one or more gears powerable by the power source.
